(19) United States
(12) Patent Application Publication
(10) Pub. No.: US 2021/0056416 A1
(43) Pub. Date: Feb. 25, 2021

(54) Distributed Deep Learning System

(71) Applicant: Nippon Telegraph and Telephone Corporation, Tokyo (JP)

(72) Inventors: Junichi Kato, Tokyo (JP); Kenji Kawai, Tokyo (JP); Huycu Ngo, Tokyo (JP); Yuki Arikawa, Tokyo (JP); Tsuyoshi Ito, Tokyo (JP); Takeshi Sakamoto, Tokyo (JP)

(21) Appl. No.: 16/979,066

(22) PCT Filed: Feb. 25, 2019
(86) PCT No.: PCT/JP2019/006962

§ 371 Date: Sep. 8, 2020

(30) Foreign Application Priority Data
Mar. 23, 2018 (JP) 2018-055734

(51) Int. Cl. G06N 3/08; G06F 13/40; G06N 3/04

(52) U.S. Cl. CPC G06N 3/08; G06N 3/04; G06F 13/4027

(57) ABSTRACT

Each of learning nodes calculates a gradient of a loss function from an output result obtained when learning data is input to a neural network to be learned, generates a packet for a plurality of gradient components, and transmits the packet to the computing interconnect device. The computing interconnect device acquires the values of a plurality of gradient components stored in the packet transmitted from each of the learning nodes, performs a calculation process in which configuration values of gradients with respect to the same configuration parameter of the neural network are input on each of a plurality of configuration values of each gradient in parallel, generates a packet for the calculation results, and transmits the packet to each of the learning nodes. Each of the learning nodes updates the configuration parameters of the neural network based on the value stored in the packet.

### TECHNICAL FIELD

The present invention relates to a distributed deep learning system that executes deep learning, which is machine learning using a neural network, in a distributed and cooperative manner with a plurality of learning nodes.

### BACKGROUND ART

The use of machine learning for a variety of information and data has led to increased provision of sophisticated and more worthy services. Such machine learning often requires large computational resources. In particular, in machine learning using a neural network called deep learning, it is necessary to process a large amount of learning data in learning, which is a step of optimizing the configuration parameters of the neural network. In order to speed up the learning step, one solution is to perform parallel processing with a plurality of operation units.

For example, NPL 1 discloses a distributed deep learning system in which four learning nodes 100-1 to 100-4, an InfiniBand switch 101, and a head node 102 are connected via an InfiniBand network as illustrated in FIG. 19. Each of the learning nodes 100-1 to 100-4 includes four GPUs (Graphics Processing Unit). In the distributed deep learning system disclosed in NPL 1, learning operations are speeded up by parallel processing using the four learning nodes 100-1 to 100-4.

NPL 2 discloses a configuration in which a learning node (GPU server) including eight GPUs and an Ethernet (registered trademark) switch are connected via an Ethernet network. NPL 2 discloses examples of use of 1, 2, 4, 8, 16, 32, and 44 learning nodes. In the system disclosed in NPL 2, machine learning is performed using a distributed synchronous SGD (Stochastic Gradient Descent). Specifically, the following procedure is performed.

(I) Extract part of learning data. A set of extracted learning data is called a mini-batch.

(II) Divide the mini-batch into datasets of the number of GPUs to allocate the datasets to the respective GPUs.

(III) In each GPU, calculate a loss function L(w) serving as an index of how much an output value from the neural network in response to an input of the learning data allocated in (II) deviates from the correct answer (called teacher data). In the step of calculating the loss function, output values are calculated in order from a layer on the input side to a layer on the output side in the neural network. Accordingly, this step is called forward propagation.

(IV) In each GPU, calculate a partial differential value (gradient) of the loss function value calculated in (III) with respect to configuration parameters of the neural network (weights of the neural network, etc.). In this step, gradients with respect to the configuration parameters of each layer are calculated in order from the layer on the output side to the layer on the input side in the neural network. Accordingly, this step is called back propagation.

(V) Calculate an average of the gradients calculated in each GPU.

(VI) In each GPU, update each configuration parameter in the neural network using the average value of the gradients calculated in (V) and using the stochastic gradient descent method (SGD) so that the loss function L(w) becomes smaller. The stochastic gradient descent is a calculation process of reducing the loss function L(w) by slightly changing the value of each configuration parameter in the gradient direction. By repeating this process, the neural network is updated to one with a small loss function L(w), that is, with a highly accurate so as to output a value close to the correct answer.

Further, NPL 3 discloses a distributed deep learning system having a configuration in which 128 learning nodes each including eight GPUs are connected via an InfiniBand network.

Any of the distributed deep learning systems in NPL 1 to NPL 3 describes that, as the number of learning nodes increases, the learning speed increases and the learning time can be reduced. In this case, in order to calculate the average value of the neural network configuration parameters such as the gradients calculated in each learning node, it is necessary to exchange these configuration parameters between the learning nodes, or the configuration parameters between the learning node and the head node of NPL 1 to perform calculations such as calculation of an average value.

On the other hand, an increased number of nodes to increase the number of parallel processes results in a greatly increasing necessary communication processes. In the case of performing an operation process such as calculation of an average value or a data transmission and reception process in the learning node or the head node by software as in the conventional techniques, there is a problem that overhead associated with communication processes increases, which makes it difficult to sufficiently increase learning efficiency.

NPL 3 discloses a relationship among the time required to perform 100 cycles of a learning process, the time for communication of the required time, and the number of GPUs. According to this relationship, as the number of GPUs increases, the time for communication increases, and especially for 512 or more GPUs, it rapidly increases.

### CITATION LIST

### Non Patent Literature

[NPL 1] Rengan Xu and Nishanth Dandapanthu., “Deep Learning Performance with NVIDIA (registered trademark) Tesla (registered trademark) P100 GPUs”, Dell Inc., 2016, Internet <http://ja.community.dell.com/techcenter/m/mediagallery/3765/download>
[NPL 2] Priya Goyal, Piotr Dollar, Ross Girshick, Pieter Noordhuis, Lukasz Wesolowski, Aapo Kyrola, Andrew Tulloch, Yangqing Jia, Kaiming He, “Accurate, Large Minibatch SGD: Training ImageNet in 1 Hour”, the United States Cornell University Library, arXiv: 1706.02677, 2017, Internet <https://arxiv.org/abs/1706.02677>
[NPL 3] Takuya Akiba, Shuji Suzuki, Keisuke Fukuda, “Extremely Large Minibatch SGD: Training ResNet-50 on ImageNet in 15 Minutes”, the United States Cornell University Library, arXiv: 1711.04325, 2017, Internet <https://arxiv.org/abs/1711.04325>

### SUMMARY OF THE INVENTION

### Technical Problem

An object of the present invention is to provide a distributed deep learning system capable of speeding up learning by parallel processing using a large number of learning nodes connected via a communication network and also capable of high-speed cooperative processing between the learning nodes connected via the communication network.

### Means for Solving the Problem

A distributed deep learning system (first embodiment) according to the present invention includes a plurality of learning nodes; and a computing interconnect device connected to the plurality of learning nodes via a communication network. Each learning node includes a gradient calculation unit that calculates, from an output result obtained when learning data is input to a neural network to be learned, a gradient of a loss function with respect to configuration parameters of the neural network; a first transmission unit that generates a packet for a plurality of component values of the gradient and transmits the packet to the computing interconnect device; a first reception unit that receives a packet transmitted from the computing interconnect device and acquires the plurality of values stored in the packet; and a configuration parameter update unit that updates corresponding configuration parameters of the neural network based on a plurality of values acquired by the first reception unit. The computing interconnect device includes a plurality of second reception units that receive packets transmitted from the learning nodes; a plurality of analysis units that acquire the plurality of component values of the gradient from each of the packets received by the second reception units; a plurality of operation units that perform a calculation process in which configuration values of gradients with respect to the same configuration parameter of the neural network are input on each of a plurality of configuration values of each gradient in parallel; a packet generation unit that generates a packet for a plurality of calculation results of the operation units; and a plurality of second transmission units that transmit the packets generated by the packet generation unit to the respective learning nodes.

Further, a distributed deep learning system (second embodiment) according to the present invention includes a plurality of learning nodes; and a computing interconnect device connected to the plurality of learning nodes via a communication network. Each learning node includes a gradient calculation unit that calculates, from an output result obtained when learning data is input to a neural network to be learned, a gradient of a loss function with respect to configuration parameters of the neural network; a first transmission unit that generates a packet for a plurality of component values of the gradient and transmits the packet to the computing interconnect device; a first reception unit that receives a packet transmitted from the computing interconnect device and acquires a plurality of values stored in the packet; and a configuration parameter update unit that updates corresponding configuration parameters of the neural network based on the plurality of values acquired by the first reception unit. The computing interconnect device includes a configuration parameter memory that stores configuration parameters of the neural network in advance; a plurality of second reception units that receive packets transmitted from the learning nodes; a plurality of analysis units that acquire the plurality of component values of the gradient from each of the packets received by the second reception units; a plurality of operation units that perform a calculation process in which configuration values of gradients with respect to the same configuration parameter of the neural network are input on each of a plurality of configuration values of each gradient in parallel; a configuration parameter update operation unit that calculates, based on a plurality of calculation results of the operation units and corresponding configuration parameters stored in the configuration parameter memory, a value of each configuration parameter after the configuration parameters are updated, to update the values of the corresponding configuration parameters stored in the configuration parameter memory; a packet generation unit that generates a packet for the updated values of the configuration parameters; and a plurality of second transmission units that transmit the packet generated by the packet generation unit to the respective learning nodes. The configuration parameter update unit of each of the learning nodes overwrites the configuration parameters of the neural network by the updated values of the configuration parameters acquired by the first reception unit.

Further, a distributed deep learning system (third embodiment) according to the present invention includes a plurality of learning nodes; and a computing interconnect device connected to the plurality of learning nodes via a communication network. Each learning node includes a gradient calculation unit that calculates, from an output result obtained when learning data is input to a neural network to be learned, a gradient of a loss function with respect to configuration parameters of the neural network; a first transmission unit that generates a packet for a plurality of component values of the gradient and transmits the packet to the computing interconnect device; a first reception unit that receives a packet transmitted from the computing interconnect device and acquires a plurality of values stored in the packet; and a configuration parameter update unit that updates corresponding configuration parameters of the neural network based on the plurality of values acquired by the first reception unit. The first transmission unit of one of the leaning nodes generates a packet for, in addition to the plurality of component values of the gradient, current values of the corresponding configuration parameters of the neural network, and transmits the packet to the computing interconnect device. The computing interconnect device includes a plurality of second reception units that receive packets transmitted from the learning nodes; a plurality of analysis units that acquire the plurality of component values of the gradient from each of the packets received by the second reception units and acquire the current values of the configuration parameters from one packet; a configuration parameter buffer that stores current values of a plurality of configuration parameters; a plurality of operation units that perform a calculation process in which configuration values of gradients with respect to the same configuration parameter of the neural network are input on each of a plurality of configuration values of each gradient in parallel; a configuration parameter update operation unit that calculates, based on a plurality of calculation results of the operation units and corresponding configuration parameters stored in the configuration parameter buffer, a value of each configuration parameter after the configuration parameters are updated; a packet generation unit that generates a packet for the updated values of the configuration parameters; and a plurality of second transmission units that transmit the packet generated by the packet generation unit to the respective learning nodes. The configuration parameter update unit of each of the learning nodes overwrites the configuration parameters of the neural network by the updated values of the configuration parameters acquired by the first reception unit.

Further, in one configuration example (first to third embodiments) of the distributed deep learning system according to the present invention, the computing interconnect device further includes a buffer configured to store the plurality of component values of the gradient transmitted from the learning nodes and to output the plurality of component values of the gradient to the plurality of operation units in parallel.

### Effects of the Invention

According to the present invention, each of the learning nodes includes the gradient calculation unit, the first transmission unit, the first reception unit, and the configuration parameter update unit, and the computing interconnect device includes the plurality of second reception units, the plurality of analysis units, the plurality of operation units, the packet generation unit, and the plurality of second transmission units, so that transmission and reception processes of a communication packet between the computing interconnect device and each learning node can be performed simultaneously in parallel at high speed by hardware processing. Accordingly, it is possible to process the distributed deep learning at higher speed than software processing of a communication process and a gradient addition process using a conventional head node. In particular, in the present invention, a calculation process in which configuration values of a gradient with respect to the same configuration parameters of a neural network are input can be performed simultaneously on each of the configuration values of the gradient simultaneously. Accordingly, it is possible to perform the calculation process at higher speed than a sequential operation using software.

Further, in the present invention, the computing interconnect device includes the configuration parameter memory that stores the configuration parameters of the neural network in advance, and the configuration parameter update operation unit that calculates, based on the plurality of calculation results of the operation units and the corresponding configuration parameters stored in the configuration parameter memory, the value of each configuration parameter after the configuration parameters are updated, so that the processing can be speeded up.

Further, in the present invention, a set of the plurality of component values of the gradient and the current values of the corresponding configuration parameters of the neural network is transmitted, and the current values of the configuration parameters are stored in the configuration parameter buffer, so that the required capacity of the configuration parameter buffer can be reduced.

### BRIEF DESCRIPTION OF DRAWINGS

FIG. 1 is a block diagram illustrating a configuration of a distributed deep learning system according to a first embodiment of the present invention.

FIG. 2 is a block diagram illustrating a configuration of a two-layer neural network.

FIG. 3 is a diagram illustrating a procedure of a conventional distributed learning process.

FIG. 4 is a diagram illustrating a procedure of a distributed learning process according to the first embodiment of the present invention.

FIG. 5 is a diagram illustrating another procedure of the distributed learning process according to the first embodiment of the present invention.

FIG. 6 is a diagram illustrating an outline of an operation of a computing interconnect device of the distributed deep learning system according to the first embodiment of the present invention.

FIG. 7 is a block diagram illustrating a configuration of the computing interconnect device of the distributed deep learning system according to the first embodiment of the present invention.

FIG. 8 is a diagram illustrating a detailed operation of the computing interconnect device of the distributed deep learning system according to the first embodiment of the present invention.

FIG. 9 is a block diagram illustrating a configuration example of a learning node of the distributed deep learning system according to the first embodiment of the present invention.

FIG. 10 is a block diagram illustrating a configuration of a distributed deep learning system according to a second embodiment of the present invention.

FIG. 11 is a diagram illustrating an outline of an operation of a computing interconnect device of the distributed deep learning system according to the second embodiment of the present invention.

FIG. 12 is a block diagram illustrating a configuration of the computing interconnect device of the distributed deep learning system according to the second embodiment of the present invention.

FIG. 13 is a diagram illustrating a detailed operation of the computing interconnect device of the distributed deep learning system according to the second embodiment of the present invention.

FIG. 14 is a block diagram illustrating a configuration example of a learning node of the distributed deep learning system according to the second embodiment of the present invention.

FIG. 15 is a block diagram illustrating a configuration of a distributed deep learning system according to a third embodiment of the present invention.

FIG. 16 is a block diagram illustrating a configuration of the computing interconnect device of the distributed deep learning system according to the third embodiment of the present invention.

FIG. 17 is a diagram illustrating a detailed operation of the computing interconnect device of the distributed deep learning system according to the third embodiment of the present invention.

FIG. 18 is a block diagram illustrating a configuration example of a learning node of the distributed deep learning system according to the third embodiment of the present invention.

FIG. 19 is a block diagram illustrating a configuration of a conventional distributed deep learning system.

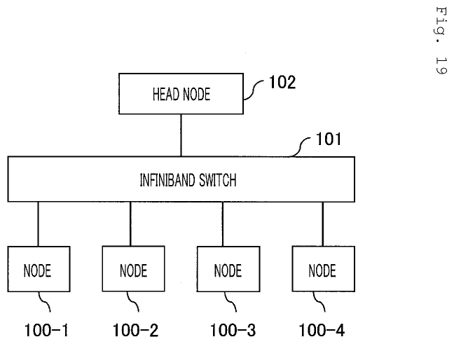

### DESCRIPTION OF EMBODIMENTS

### First Embodiment

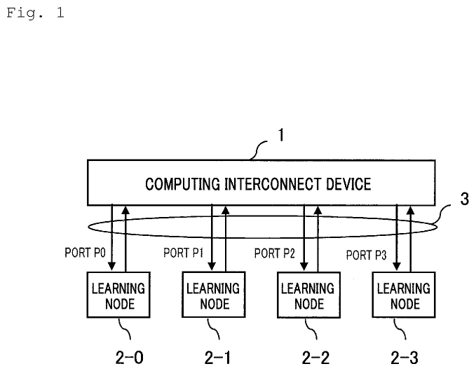

Hereinafter, embodiments of the present invention will be described with reference to the drawings. FIG. 1 is a block diagram illustrating a configuration of a distributed deep learning system according to a first embodiment of the present invention. The distributed deep learning system of the present embodiment includes one computing interconnect (CI: Computing Interconnect) device 1 and four learning nodes 2-0 to 2-3.

Note that, in the present invention, the computing interconnect device or the learning node means one of devices that are distributed and arranged on a network.

The computing interconnect device 1 includes four communication ports P0 to P3, and the communication ports P0 to P3 are connected to communication ports of the learning nodes 2-0 to 2-3 via a communication network 3, respectively. As the communication network 3, a network that provides communication through the exchange of communication packets, such as Ethernet or InfiniBand, is used.

<Description of Learning Node>

The learning nodes 2-0 to 2-3 is each a device having a learning function of calculating output values of a neural network, which is a mathematical model, and further updating configuration parameters of the neural network according to learning data to improve the accuracy of the output values. The neural network is constructed in each of the learning nodes 2-0 to 2-3.

The learning nodes 2-0 to 2-3 may be implemented by software on a CPU (Central Processing Unit) or a GPU, or may be implemented by an LSI (Large Scale Integration) circuit formed in an FPGA (Field Programmable Gate Array) or an ASIC (Application Specific Integrated Circuit).

<Description of Learning>

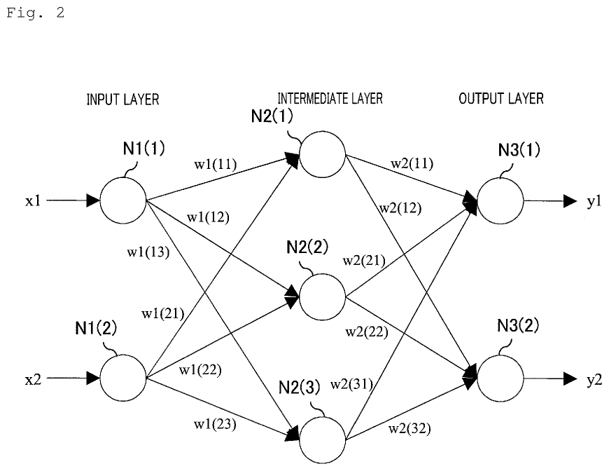

A learning process of the neural network in the learning nodes 2-0 to 2-3 will be described using learning with teacher data by way of example. FIG. 2 illustrates a simple two-layer neural network including an input layer (first layer), an intermediate layer (second layer), and an output layer (third layer) as an example of the neural network. In FIG. 2, Nk(i) indicates the k-th layer and the i-th neuron. Also, x1 and x2 are inputs, y1 and y2 are outputs, w1(11), w1(12), . . . , w1(23) are weight parameters of the first layer, w2(11), w2(12), . . . , w2(32) are weight parameters of the second layer.

In the case of learning with teacher data, corresponding teacher data (correct data) is prepared in advance for each learning data, and configuration parameters of the neural network are updated so that the output values of the neural network are closer to the teacher data. The configuration parameters of the neural network in the case of the example of FIG. 2 are weights w1(11), w1(12), . . . , w1(23), w2(11), w2(12), . . . , w2(32). Optimizing these configuration parameters improves the accuracy of the neural network.

Specifically, a loss function as an index of how much the output values of the neural network deviate from the teacher data is calculated, and the configuration parameters are updated so that the loss function becomes smaller. In this example, assuming that the output values corresponding to the input learning data x1 and x2 are y1 and y2 and the teacher data is t1 and t2, a loss function L is, for example, as follows.

[Formula 1]

L=½Σₖ₌₁²(yₖ−tₖ)² (1)

Next, a vector (hereinafter, referred to as a gradient) having, as components, partial differential values of the loss function L with respect to the configuration parameters of the neural network is calculated. In this example, the gradient is as follows.

$$\begin{matrix} [ Formula 2 ] & \\ ( \frac{\partial L}{\partial w 1 ( 11 )} , \frac{\partial L}{\partial w 1 ( 12 )} , … , \frac{\partial L}{\partial w 1 ( 23 )} , \frac{\partial L}{\partial w 2 ( 11 )} , \frac{\partial L}{\partial w 1 ( 12 )} , … , \frac{\partial L}{\partial w 2 ( 32 )} ) & ( 2 )\end{matrix}$$

Next, each configuration parameter of the neural network is updated using the gradient so that the loss function L becomes smaller. There are various types of update methods. For example, each weight parameter is updated using gradient descent as follows.

$$\begin{matrix}[ Formula 3 ] & \\ w 1 ( 11 ) ← w 1 ( 11 ) - η \frac{\partial L}{\partial w 1 ( 11 )} \\ … \\ w 2 ( 32 ) ← w 2 ( 32 ) - η \frac{\partial L}{\partial w 2 ( 32 )} & ( 3 )\end{matrix}$$

Here, η is a constant called a learning rate. According to Equation (3), each weight parameter is changed in a direction opposite to the gradient, that is, in a direction of reducing the loss function L by an amount proportional to the learning rate T. Accordingly, the loss function L of the updated neural network becomes smaller than before the update.

In this way, the process of calculating the loss function L, calculating the gradient, and updating the configuration parameters is performed on a set of input learning data. Then, the same process is performed by inputting the next input learning data to the neural network having the updated configuration parameters, so that the configuration parameters are further updated. By repeating this cycle, the neural network is updated to one with a smaller loss function L, so that learning of the neural network is performed.

Here, in the step of calculating the loss function L, output values are calculated in order from the input layer to the output layer in the neural network. Accordingly, this step is called forward propagation. On the other hand, in the step of calculating the gradient, a method called back propagation is often used in which gradients with respect to the configuration parameters of each layer are calculated in order from the output layer to the input layer in the neural network.

<Distributed Learning Process by Multiple Learning Nodes>

In order to achieve sufficient accuracy by learning of the neural network as described above, it is necessary to input a large amount of learning data to the neural network and repeat the learning process, which takes a long time. Reducing the time required for the learning has a great advantage.

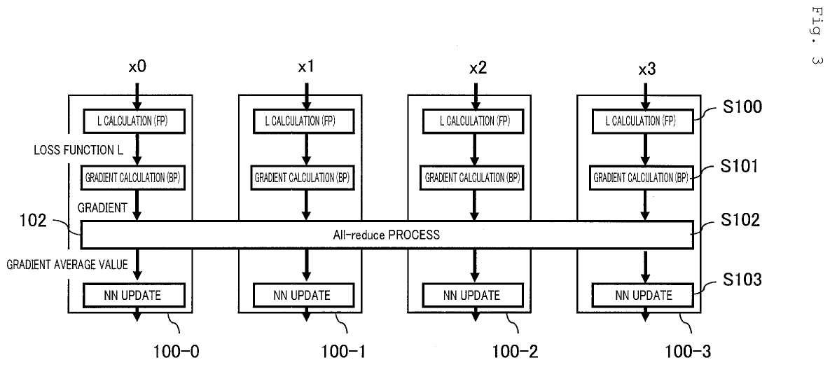

In order to reduce the time required for learning, a distributed cooperative learning method is used in which a plurality of learning nodes each having the same neural network are prepared, and learning data is divided into pieces for the respective learning nodes and learned in parallel so that total learning time is reduced. A procedure of a conventional distributed learning process will be described with reference to FIG. 3.

First, the learning data x is divided into pieces of the number of learning nodes 100-0 to 100-3 and allocated to the learning nodes 100-0 to 100-3, respectively. Note that, in FIG. 3, although x0 to x3 are shown one by one as representatives of the learning data to be allocated to the learning nodes 100-0 to 100-3, the learning data x0 to x3 is each a set of one or more pieces of learning data.

Next, the learning nodes 100-0 to 100-3 input the learning data x0 to x3 to the own neural network, respectively and each calculate a loss function L by the forward propagation method (step S100 in FIG. 3). Note that one loss function L is obtained for each of the learning nodes 100-0 to 100-3 (each neural network).

Subsequently, each of the learning nodes 100-0 to 100-3 calculates a gradient of the loss function L calculated in step S100 by the back propagation method (step S101 in FIG. 3). The gradient of the loss function L is a vector including components corresponding to the configuration parameters as represented in Equation (2).

Next, an average of the gradients calculated in the respective learning nodes 100-0 to 100-3 is calculated in, for example, a head node 102, and a result of calculation is returned from the head node 102 to each of the learning nodes 100-0 to 100-3 (step S102 in FIG. 3). This process is referred to as an All-reduce process. Note that a sum of the gradients may be calculated instead of the average of the gradients. In this case, for example, when the learning rate T at the time of the next update process for weight parameters is multiplied by 1/(the number of learning nodes), the resulting value is the same as that of calculation of the average value of the gradients.

Finally, each of the learning nodes 100-0 to 100-3 updates the weight parameters of the neural network using the average value of the gradient calculated in step S102 (step S103 in FIG. 3).

Thus, one cycle of distributed learning is completed.

### Distributed Process of the Present Embodiment

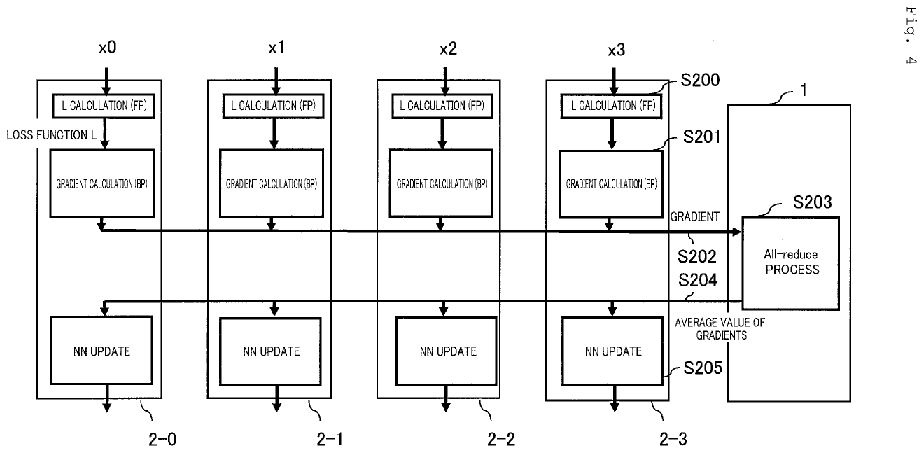

Next, a procedure of a distributed learning process according to the present embodiment will be described with reference to FIG. 4. In the present embodiment, the learning nodes 2-0 to 2-3 input the learning data x0 to x3 to their own neural network, respectively and each calculate a loss function L, as in the conventional process (step S200 in FIG. 4). Subsequently, a gradient of the loss function L is calculated (step S201 in FIG. 4). Then, each of the learning nodes 2-0 to 2-3 transmits a calculated value of the calculated gradient to the computing interconnect device 1 connected to the learning nodes 2-0 to 2-3 via a communication network (steps S202 in FIG. 4).

Note that, in FIG. 4 as in FIG. 3, although x0 to x3 are shown one by one as representatives of the learning data to be allocated to the learning nodes 2-0 to 2-3, the learning data x0 to x3 is each a set of one or more pieces of learning data.

Next, the computing interconnect device 1 performs an All-reduce process of calculating an average value of the gradients transmitted from the learning nodes 2-0 to 2-3, and transmitting a result of calculation to each of the learning nodes 2-0 to 2-3 (steps S203 and S204 in FIG. 4).

Finally, each of the learning nodes 2-0 to 2-3 updates the configuration parameters of the neural network by using the average value of the gradients transmitted from the computing interconnect device 1 (step S205 in FIG. 4).

Note that a sum of the gradients may be calculated instead of the average of the gradients. In this case, for example, when the learning rate T at the time of the next update process for weight parameters is multiplied by 1/(the number of learning nodes), the resulting value is the same as that of calculation of the average value of the gradients. Further, a weighted average may be used in which each gradient is multiplied by a weighting constant, or a root mean square of the gradients may be used.

Thus, one cycle of distributed learning according to the present embodiment is completed.

Normally, the gradient calculation is to calculate components of a gradient with respect to configuration parameters (weight parameters) for each layer in order from the output layer to the input layer of the neural network in accordance with the back propagation method. Therefore, to transmit the gradient calculation results of the learning nodes 2-0 to 2-3 to the computing interconnect device 1, it is not necessary to wait until the gradient calculations for all the layers are completed.

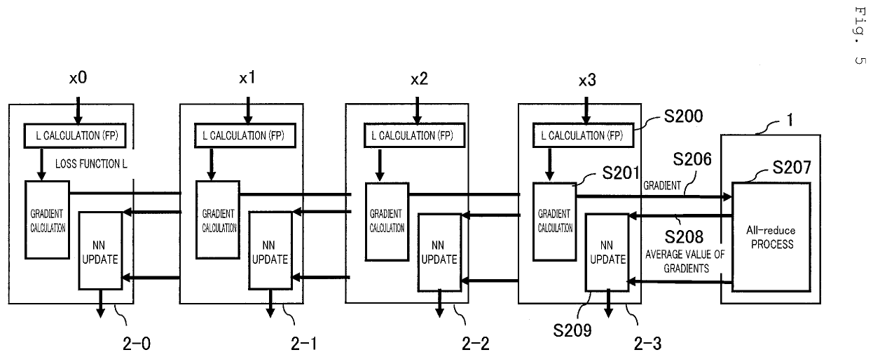

Accordingly, each of the learning nodes 2-0 to 2-3 calculates a loss function L in the same manner as described above (step S200 in FIG. 5), and calculates a gradient of the loss function L (step S201 in FIG. 5). Meanwhile, each of the learning nodes 2-0 to 2-3 can transmit the gradient components with respect to the calculated configuration parameters to the computing interconnect device 1 without waiting for the completion of the calculation of the gradient components with respect to all the configuration parameters in step S201 (step S206 in FIG. 5).

The computing interconnect device 1 calculates an average value of the gradient components transmitted from the learning nodes 2-0 to 2-3 (step S207 in FIG. 5), and transmits the calculated average value of the gradient components to each of the learning nodes 2-0 to 2-3 (step S208 in FIG. 5).

When receiving the calculation result from the computing interconnect device 1, each of the learning nodes 2-0 to 2-3 does not wait until all the calculation results are received, and updates, using the received average value of the gradient components, the corresponding configuration parameters (step S209 in FIG. 5).

In this way, the gradient calculation, the All-reduce process, and the configuration parameter update can be processed in a pipeline manner, so that the processing can be speeded up more.

<Outline of Operation of Computing Interconnect Device>

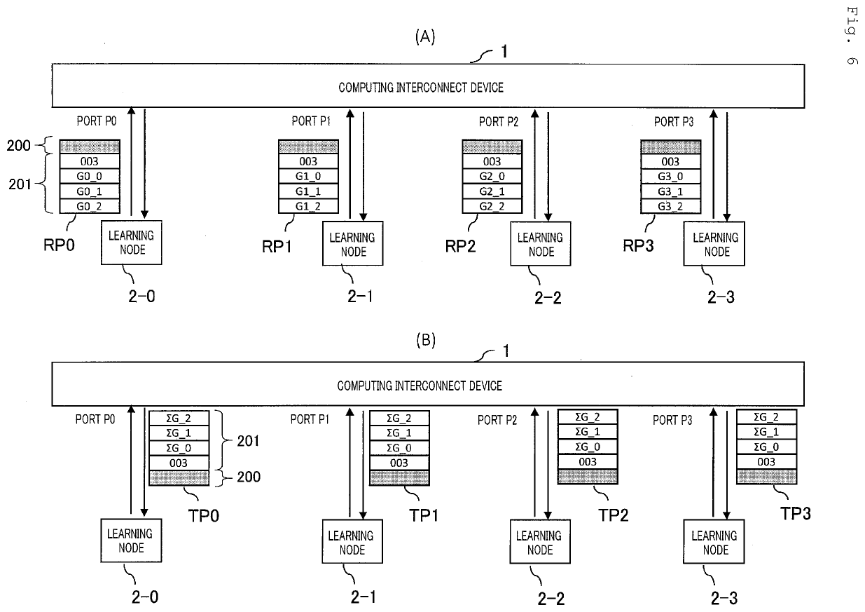

FIGS. 6(A) and 6(B) are diagrams illustrating an outline of an operation of the computing interconnect device 1. As is well known, a communication packet is composed of a header 200 and a data payload 201.

When calculating the gradient components with respect to the respective configuration parameters, each of the learning nodes 2-0 to 2-3 stores the calculation result in the corresponding data payload of the communication packets RP0 to RP3 and transmits the packets to the computing interconnect device 1. For example, in an example of FIG. 6(A), the learning node 2-0 stores three gradient component values G0_0, G0_1, and G0_2 in the data payload of the communication packet RP0 and transmits the packet to the computing interconnect device 1. At this time, the sequential number (“003” in the example of FIG. 6 (A)) of the communication packet is also stored in the data payload.

Control of calculating a sum of the corresponding gradient components stored in the communication packets having the same sequential number from the learning nodes 2-0 to 2-3 guarantees that addition operation of the corresponding gradient components of the learning nodes 2-0 to 2-3 is possible.

In the present invention, it is assumed that the same neural network is constructed in each of the learning nodes 2-0 to 2-3 having the same configuration, and learning data is divided into pieces corresponding to the learning nodes 2-0 to 2-3 so that learning is performed in parallel. The order of processes performed in each of the learning nodes 2-0 to 2-3 and the specifications of communication packets are the same for all the learning nodes 2-0 to 2-3. Accordingly, in communication packets, having the same sequential number, transmitted from the learning nodes 2-0 to 2-3, a gradient component with respect to the same configuration parameter is stored at the same position in each communication packet.

In the example of FIG. 6(A), among the gradient values G0 to G3 stored respectively in the communication packets RP0 to RP3, values having the same sign after “ ” represent gradient component values for the same configuration parameter of the neural network. For example, G0_0, G1_0, G2_0, G3_0 are gradient components calculated by the learning nodes 2-0 to 2-3 for the same configuration parameter. Further, G0_1, G1_1, G2_1, and G3_1 are gradient components calculated by the learning nodes 2-0 to 2-3 for another configuration parameter of the neural network.

When receiving the communication packets RP0 to RP3 having the same sequential number from all the learning nodes 2-0 to 2-3, the computing interconnect device 1 calculates a sum of the corresponding gradient component values for the same configuration parameter of the neural network by the following equation.

ΣG_0=G0_0+G1_0+G2_0+G3_0 (4)

ΣG_1=G0_1+G1_1+G2_1+G3_1 (5)

ΣG_2=G0_2+G1_2+G2_2+G3_2 (6)

Then, the computing interconnect device 1 stores the calculation results of the calculated sums of the gradient components, ΣG_0, ΣG_1, and ΣG_2, in the data payloads of the communication packets TP0 to TP3, respectively, and transmits the calculation results to each of the learning nodes 2-0 to 2-3 (FIG. 6(B)). At this time, the computing interconnect device 1 stores the results ΣG_0, ΣG_1, and ΣG_2 calculated from the gradients stored in the communication packets RP0 to RP3 from the learning nodes 2-0 to 2-3 in the data payload of each of the communication packets TP0 to TP3 in the same order as that of the original gradient components.

<Configuration of Computing Interconnect Device>

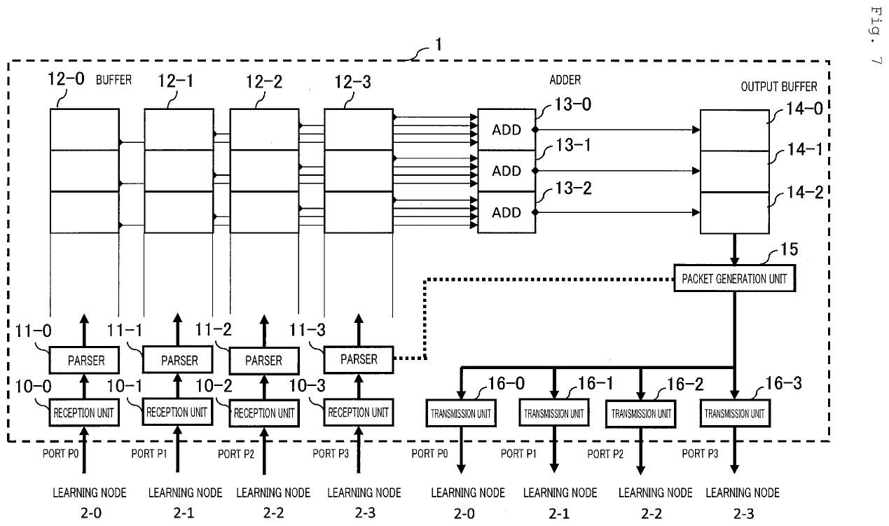

FIG. 7 illustrates a configuration of the computing interconnect device 1 of the present embodiment. The computing interconnect device 1 includes transmission and reception ports P0 to P3, reception units 10-0 to 10-3, parsers (analysis units) 11-0 to 11-3, buffers 12-0 to 12-3, adders (operation units) 13-0 to 13-2, output buffers 14-0 to 14-2, a packet generation unit 15, and transmission units 16-0 to 16-3. The transmission and reception ports P0 to P3 are connected to the learning nodes 2-0 to 2-3, respectively, by the communication network 3. The reception units 10-0 to 10-3 are provided for the respective learning nodes 2-0 to 2-3 to receive communication packets transmitted from the learning nodes 2-0 to 2-3. The parsers (analysis units) 11-0 to 11-3 are provided for the respective learning nodes 2-0 to 2-3 to analyze the headers and data payloads of the communication packets received by the respective reception units 10-0 to 10-3. The buffers 12-0 to 12-3 are provided for the respective learning nodes 2-0 to 2-3 to temporarily store the calculation results of the gradients stored in the communication packets received by the respective reception units 10-0 to 10-3. The adders (operation units) 13-0 to 13-2 are provided in the same number as the number of parallel output stages of the buffers 12-0 to 12-3 to perform a process of calculating a sum of gradients with respect to the same configuration parameter for each of a plurality of gradients in parallel. The output buffers 14-0 to 14-2 are provided in the same number as the number of parallel output stages of the buffers 12-0 to 12-3 to temporarily store the calculation results of the sums of the gradients calculated by the adders 13-0 to 13-2. The packet generation unit 15 generates communication packets, in each of which the calculation result of the corresponding sum of the gradients stored in the output buffers 14-0 to 14-2 is stored in the data payload. The transmission units 16-0 to 16-3 are provided for the respective learning nodes 2-0 to 2-3 to transmit the communication packets generated by the packet generation unit 15 to the learning nodes 2-0 to 2-3.

Note that FIFO memories may be used as the buffers 12-0 to 12-3. Further, instead of calculating a sum of the gradients, an operation unit for calculating an average value of the gradients may be used as the adders 13-0 to 13-2.

<Operation of Computing Interconnect Device>

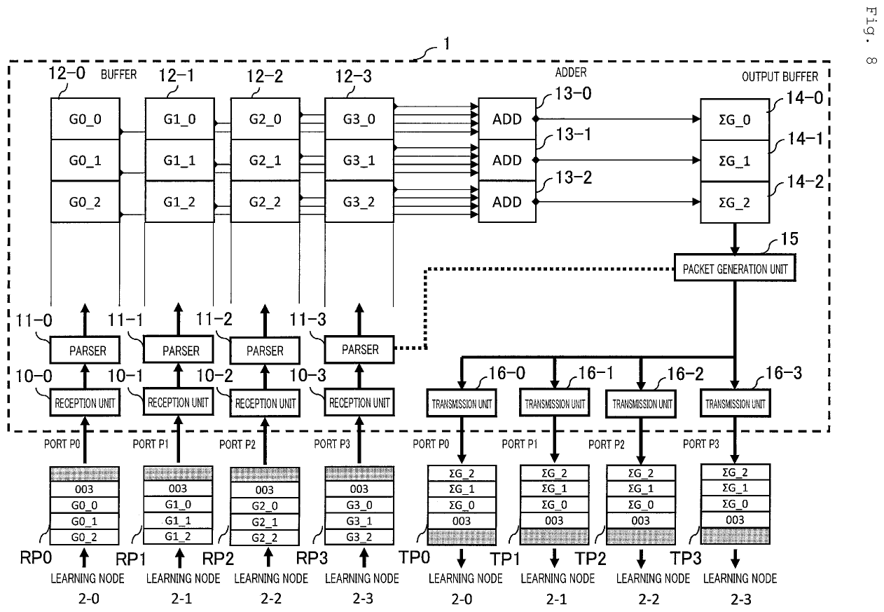

Next, a detailed operation of the computing interconnect device 1 will be described with reference to FIG. 8. The reception units 10-0 to 10-3 of the computing interconnect device 1 receive the communication packets RP0 to RP3 from the learning nodes 2-0 to 2-3, respectively.

The parsers 11-0 to 11-3 of the computing interconnect device 1 analyze the contents of the headers and data payloads of the communication packets RP0 to RP3 received by the reception units 10-0 to 10-3, respectively, extract the gradient values from the data payloads, and store the values in the buffers 12-0 to 12-3. The reason why the values are temporarily stored in the buffers 12-0 to 12-3 is that, even for the communication packets assigned the same sequential number (i.e., communication packets corresponding to the same configuration parameter), they do not always arrive at exactly the same timing from the learning nodes 2-0 to 2-3.

When the parsers 11-0 to 11-3 write, into the buffers 12-0 to 12-3, the gradient component values G0_0 to G3_0, G0_1 to G3_1, and G0_2 to G3_2 extracted from the communication packets RP0 to RP3 assigned the same sequential number which have been received from all the corresponding learning nodes 2-0 to 2-3, the parsers 11-0 to 11-3 cause the buffers 12-0 to 12-3 to output the gradient component values.

The buffers 12-0 to 12-3 can store the gradient component values G0_0 to G3_0, G0_1 to G3_1, and G0_2 to G3_2 written by the parsers 11-0 to 11-3 in order, and output them in parallel. If the number n_{buff} of parallel output stages of each of the buffers 12-0 to 12-3 is smaller than the maximum number n_{data} of gradient component values that can be stored in the data payload of each of the communication packets RP0 to RP3, n_{data} pieces of data may be divided into every n_{buff} data pieces and perform parallel calculation several times. In the examples of FIGS. 7 and 8, n_{buff}=n_{data}=3. That is, each of the buffers 12-0 to 12-3 can simultaneously output three gradient component values.

Further, the parsers 11-0 to 11-3 pass, to the packet generation unit 15, the sequential number (“003” in the example of FIG. 8) for the gradient component values G0_0 to G3_0, G0_1 to G3_1, and G0_2 to G3_2 output from the buffers 12-0 to 12-3.

Each of the adders 13-0 to 13-2 of the computing interconnect device 1 calculates a sum of the gradient component values output from the buffers 12-0 to 12-3 at the corresponding output stage of the buffers 12-0 to 12-3. The adders 13-0 to 13-2 are provided in the same number as the number n_{buff} of parallel output stages of the buffers 12-0 to 12-3, and are arranged in ascending order according to the order of the configuration parameters. Then, as described above, the parsers 11-0 to 11-3 write, into the buffers 12-0 to 12-3, the gradient component values extracted from the communication packets assigned the same sequential number which have been received from the respective learning nodes 2-0 to 2-3, and the buffers 12-0 to 12-3 store the gradient component values written by the respective parsers 11-0 to 11-3 in order.

Accordingly, since each of the gradient component values output from the same output stage of the buffers 12-0 to 12-3 is a gradient component value with respect to the same configuration parameter of the neural network, the adders 13-0 to 13-2 calculate the sums of the corresponding gradient component values with respect to the same configuration parameter, ΣG_0 to ΣG_2 as in Equations (4) to (6).

The output buffers 14-0 to 14-2 of the computing interconnect device 1 are provided in the same number as the number n_{buff} of parallel output stages of the buffers 12-0 to 12-3, and are arranged in ascending order according to the order of the configuration parameters. The output buffer 14-0 to 14-2 temporarily store the calculation results of the sums of the gradient components, ΣG_0 to ΣG_2 calculated by the respective adders 13-0 to 13-2.

The packet generation unit 15 of the computing interconnect device 1 stores the sequential number received from the parsers 11-0 to 11-3 in the data payloads of the communication packets TP0 to TP3 addressed to the respective learning nodes 2-0 to 2-3. At the same time, the packet generation unit 15 reads out the calculation results of the sums of the gradient components, ΣG_0 to ΣG_2 stored in the output buffers 14-0 to 14-2, and stores them in the data payload of each of the communication packets TP0 to TP3. At the same time, the packet generation unit 15 stores the calculation results of the sums of the gradient components, ΣG_0 to ΣG_2 stored in the output buffers 14-0 to 14-2 in the data payload of each of the communication packets TP0 to TP3 in the order of the output buffers 14-0 to 14-2 (i.e., the order of the original gradients G0_0 to G3_0, G0_1 to G3_1, and G0_2 to G3_2).

Then, the transmission units 16-0 to 16-3 of the computing interconnect device 1 simultaneously transmit the communication packets TP0 to TP3 generated by the packet generation unit 15 to the respective learning nodes 2-0 to 2-3.

The above-described computing interconnect device 1 can be implemented by an LSI circuit formed in an FPGA or an ASIC. The same applies to computing interconnect devices according to the following other embodiments.

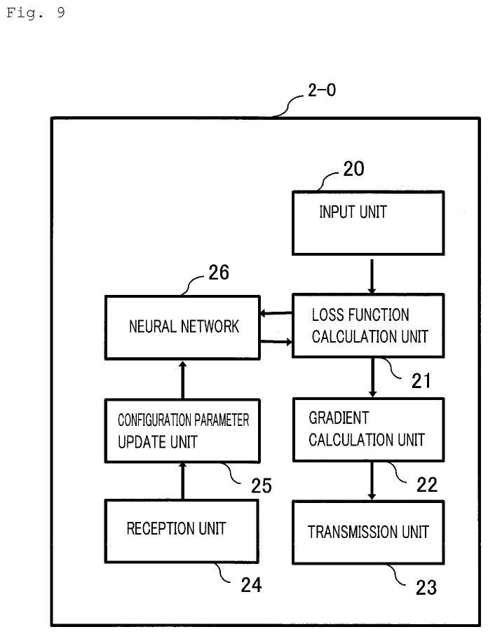

FIG. 9 is a block diagram illustrating a configuration example of the learning node 2-0. The learning node 2-0 includes an input unit 20 that receives learning data, a loss function calculation unit 21 that calculates a loss function L when learning data is input, a gradient calculation unit 22 that calculates a gradient of the loss function L, a transmission unit 23 that generates a packet of the gradient values calculated by the gradient calculation unit 22 and transmits the packet to the computing interconnect device 1, a reception unit 24 that receives a communication packet transmitted from the computing interconnect device 1, a configuration parameter update unit 25 that updates configuration parameters (weight parameters) of a neural network by using a sum of gradients stored in the communication packet transmitted from the computing interconnect device 1, and a neural network 26 having a function of calculating an output value of the neural network which is a mathematical model.

Although the example of FIG. 9 illustrates the configuration of the learning node 2-0, the configurations of the other learning nodes 2-1 to 2-3 are the same as those of the learning node 2-0.

The gradient calculation unit 22 of each of the learning nodes 2-0 to 2-3 calculates the gradient of the loss function L.

The transmission unit 23 of each of the learning nodes 2-0 to 2-3 writes the corresponding calculation results of the gradient components, G0_0 to G0_2, G1_0 to G1_2, G2_0 to G2_2, and G3_0 to G3_2 calculated by the gradient calculation unit 22, and the sequential number into the data payload of the corresponding one of the communication packets RP0 to RP3, and transmits the packet to the computing interconnect device 1. At this time, the transmission unit 23 of each of the learning nodes 2-0 to 2-3 stores the corresponding calculation result of the gradient components, G0_0 to G0_2, G1_0 to G1_2, G2_0 to G2_2, and G3_0 to G3_2 calculated by the gradient calculation unit 22 in the data payload of the corresponding one of the communication packets RP0 to RP3 in the order of the corresponding configuration parameters of the neural network 26.

If the number of gradient components is larger than the maximum number n_{data} of gradient component values that can be stored in the data payload of each of the communication packets RP0 to RP3, the gradient components may be divided into every n_{data} data pieces so as to be stored in a plurality of communication packets and transmitted. In this case, the gradient component of the data stored in the data payload is identified by the sequential number assigned to each communication packet. FIG. 8 illustrates an example for n_{data}=3.

The reception unit 24 of each of the learning nodes 2-0 to 2-3 extracts the calculation results of the sums of the gradient components, ΣG_0 to ΣG_2 from the data payload of the corresponding one of the communication packets TP0 to TP3 received from the computing interconnect device 1.

As described above, the data payloads of the communication packets RP0 to RP3 transmitted from the learning nodes 2-0 to 2-3 to the computing interconnect device 1 include the calculation results of the gradient components, G0_0 to G0_2, G1_0 to G1_2, G2_0-G2_2, and G3_0-G3_2 are stored in the order of the configuration parameters of the neural network 26. Then, the computing interconnect device 1 returns the calculation results of the sums of the gradient components, ΣG_0 to ΣG_2 stored in the data payloads of the communication packets TP0 to TP3 in the same order as that of the gradient components.

Since the calculation results of the sums of the gradient components, ΣG_0 to ΣG_2 extracted by the reception unit 24 of each of the learning nodes 2-0 to 2-3 are arranged in the order of the corresponding configuration parameters, it is possible for the configuration parameter update unit 25 of each of the learning nodes 2-0 to 2 to update the corresponding configuration parameters of the neural network 26 based on the calculation results of the sums of the gradient components, ΣG_0 to ΣG_2.

As described above, in the present embodiment, by using the computing interconnect device 1 for the All-reduce process, it is possible to perform the transmission and reception processes of communication packets between the computing interconnect device 1 and each of the learning nodes 2-0 to 2-3 simultaneously at high speed by hardware but with a slight delay due to variations in the arrival time of a communication packet among the learning nodes 2-0 to 2-3. Accordingly, it is possible to perform the processing at higher speed than software processing of a communication process and a gradient addition process using a conventional head node.

Further, in the present embodiment, since the calculated values of the sums ΣG_0 to ΣG_2 of the plurality of gradient components from the learning nodes 2-0 to 2-3 are calculated by the plurality of adders 13-0 to 13-2 of the computing interconnect device 1 simultaneously, it is possible to perform the processing at higher speed than a sequential operation using software.

### Second Embodiment

Next, a second embodiment of the present invention will be described. In the first embodiment, the computing interconnect device 1 performs sum operation on the gradients, and each of the learning nodes 2-0 to 2-3 performs update operation on the configuration parameters of the neural network. By contrast, in the present embodiment, the computing interconnect device not only performs the sum operation on the gradients but also the update operation on the configuration parameters of the neural network.

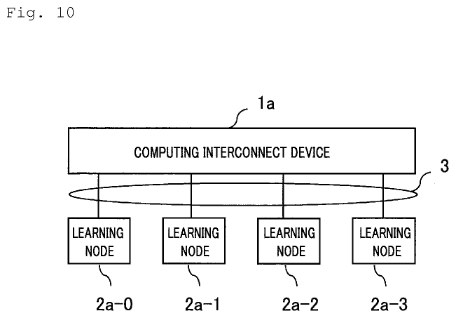

FIG. 10 is a block diagram illustrating a configuration of a distributed deep learning system according to the present embodiment. The distributed deep learning system according to the present embodiment includes one computing interconnect device 1a, four learning nodes 2a-0 to 2a-3, and a communication network 3 connecting the computing interconnect device 1a and the learning nodes 2a-0 to 2a-3.

<Outline of Operation of Computing Interconnect Device>

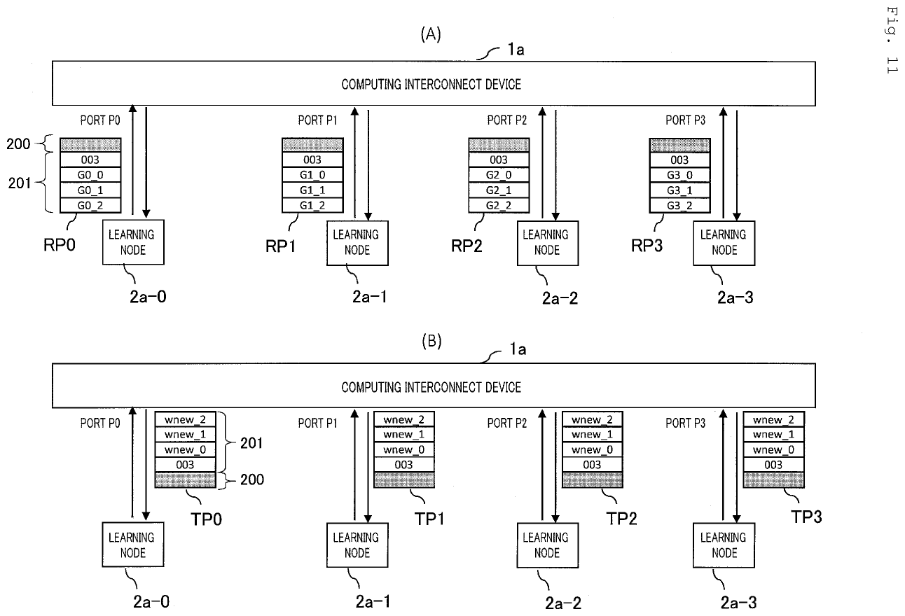

FIGS. 11(A) and 11(B) are diagrams illustrating an outline of an operation of the computing interconnect device 1a according to the present embodiment.

As in the first embodiment, each of the learning nodes 2a-0 to 2a-3 calculates a gradient of a loss function with respect to configuration parameters of a neural network, and stores the calculation result in the data payload of the corresponding one of the communication packets RP0 to RP3, and transmits the packet to the computing interconnect device 1a. For example, in an example of FIG. 11(A), the learning node 2a-0 stores three gradient component values G0_0, G0_1, and G0_2 in the data payload of the communication packet RP0 and transmits the packet to the computing interconnect device 1a. At this time, the sequential number (“003” in the example of FIG. 11 (A)) of the communication packet is also stored in the data payload.

Control of calculating a sum of the corresponding gradient components stored in the communication packets having the same sequential number from the learning nodes 2a-0 to 2a-3 guarantees that addition operation on the corresponding gradient components of the learning nodes 2a-0 to 2a-3 is possible.

When receiving the communication packets RP0 to RP3 having the same sequential number from all the learning nodes 2a-0 to 2a-3, the computing interconnect device 1a calculates sums of the corresponding gradient component values for the same configuration parameter of the neural network, ΣG_0, ΣG_1, and ΣG_2 as in Equations (4) to (6).

Further, the computing interconnect device 1a calculates values wnew_0, wnew_1, and wnew_2 of the respective configuration parameters after the configuration parameters of the neural network are updated, based on the calculation results of the calculated sums of the gradient components, ΣG_0, ΣG_1, and ΣG_2. Then, the computing interconnect device 1a stores updated values wnew_0, wnew_1, and wnew_2 of the configuration parameters in the data payload of each of the communication packets TP0 to TP3, and transmits the packets to the learning nodes 2a-0 to 2a-3 (FIG. 11 (B)).

At this time, the computing interconnect device 1a stores the updated values wnew_0, wnew_1, and wnew_2 of the configuration parameters calculated from the gradient components stored in the communication packets RP0 to RP3 from the learning nodes 2a-0 to 2a-3 in the data payload of each of the communication packets TP0 to TP3 in the same order as that of the original gradient components.

<Configuration of Computing Interconnect Device>

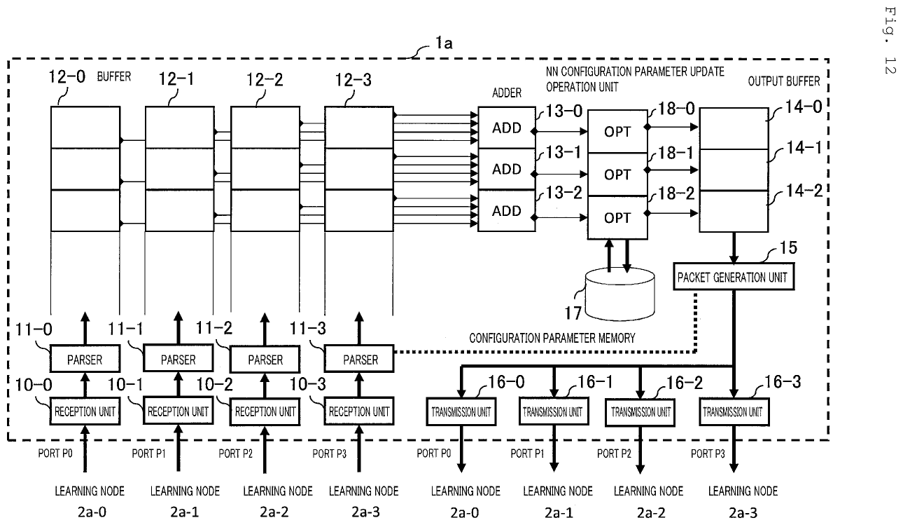

FIG. 12 is a block diagram illustrating a configuration of the computing interconnect device 1a according to the present embodiment, where the same components as those in FIG. 7 are denoted by the same reference numerals. The computing interconnect device 1a according to the present embodiment includes the transmission and reception ports P0 to P3 connected, respectively, to the learning nodes 2a-0 to 2a-3 via the communication network 3, the reception units 10-0 to 10-3, the parsers 11-0 to 11-3, the buffers 12-0 to 12-3, the adders 13-0 to 13-2, the output buffers 14-0 to 14-2, the packet generation unit 15, the transmission units 16-0 to 16-3, a configuration parameter memory 17 that stores configuration parameters of a neural network 26 to be learned by each of the learning nodes 2a-0 to 2a-3, and NN (neural network) configuration parameter update calculation units 18-0 to 18-2 that calculate updated values of the configuration parameters (weight parameters) of the neural network.

<Operation of Computing Interconnect Device>

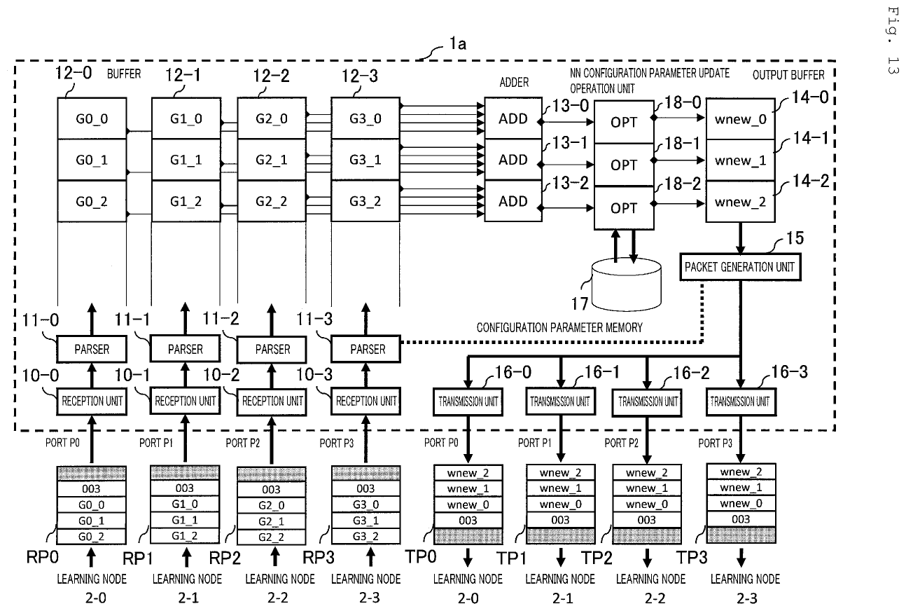

Next, a detailed operation of the computing interconnect device 1a will be described with reference to FIG. 13. At the start of learning, in the neural network 26 of each of the learning nodes 2a-0 to 2a-3, same initial values of configuration parameters are set for all the learning nodes 2a-0 to 2a-3. All the initial values of the configuration parameters are transmitted from the learning nodes 2a-0 to 2a-3 to the computing interconnect device 1a by using communication packets.

When receiving the initial values of the configuration parameters, the computing interconnect device 1a stores the initial values of the configuration parameters in the configuration parameter memory 17. The initial values of the configuration parameters are stored in a predetermined order, that is, the order in which the gradient is to be calculated in each of the learning nodes 2a-0 to 2a-3 and written in the communication packet.

As in the first embodiment, each of the learning nodes 2a-0 to 2a-3 inputs learning data to the own neural networks 26 in which the initial values of the configuration parameters are set, and calculates a loss function L. Next, a gradient of the loss function L is calculated. Then, the transmission unit 23 of each of the learning nodes 2a-0 to 2a-3 writes the corresponding calculation results of the gradient components calculated by the gradient calculation unit 22, and the sequential number into the data payload of the corresponding one of the communication packets RP0 to RP3, and transmits the packet to the computing interconnect device 1a.

Accordingly, in the data payloads of the communication packets RP0 to RP3 received by the reception units 10-0 to 10-3 of the computing interconnect device 1a, the gradient component values calculated by the learning nodes 2a-0 to 2a-3 (G0_0 to G0_2, G1_0 to G1_2, G2_0 to G2_2, and G3_0 to G3_2 in FIG. 13) and a sequential number (“003” in the example of FIG. 13) are stored.

If the number of gradient components is larger than the maximum number n_{data} of gradient component values that can be stored in the data payload of each of the communication packets RP0 to RP3, the gradient components may be divided into every n_{data} data pieces so as to be stored in a plurality of communication packets and transmitted. In this case, the gradient component of the data stored in the data payload is identified by the sequential number assigned to each communication packet. FIG. 13 illustrates an example for n_{data}=3.

The parsers 11-0 to 11-3 of the computing interconnect device 1a analyze the contents of the headers and data payloads of the communication packets RP0 to RP3 received by the reception units 10-0 to 10-3, respectively, extract the gradient values from the data payloads, and store the values in the buffers 12-0 to 12-3. As described in the first embodiment, the reason why the values are temporarily stored in the buffers 12-0 to 12-3 is that, even for the communication packets assigned the same sequential number, they do not always arrive at exactly the same timing from the learning nodes 2a-0 to 2a-3.

When the parsers 11-0 to 11-3 write, into the buffers 12-0 to 12-3, the gradient component values G0_0 to G3_0, G0_1 to G3_1, and G0_2 to G3_2 extracted from the communication packets RP0 to RP3 assigned the same sequential number which have been received from all the corresponding learning nodes 2a-0 to 2a-3, the parsers 11-0 to 11-3 cause the buffers 12-0 to 12-3 to output the gradient component values.

As in the first embodiment, the buffers 12-0 to 12-3 can store the gradient component values G0_0 to G3_0, G0_1 to G3_1, and G0_2 to G3_2 written by the parsers 11-0 to 11-3 in order, and output them in parallel. Further, the parsers 11-0 to 11-3 pass, to the packet generation unit 15, the sequential number (“003” in the example of FIG. 13) for the gradient component values G0_ to G3_0, G0_1 to G3_1, and G0_2 to G3_2 output from the buffers 12-0 to 12-3.

The adders 13-0 to 13-2 of the computing interconnect device 1a are provided in the same number as the number of parallel output stages n_{buff} of the buffers 12-0 to 12-3, and calculates a sum of the gradient component values output from the buffers 12-0 to 12-3 at the corresponding output stage of the buffers 12-0 to 12-3. As a result, the adders 13-0 to 13-2 calculate the sums of the corresponding gradient component values, ΣG_0 to ΣG_2 with respect to the same configuration parameters as in Equations (4) to (6).

The NN configuration parameter update calculation units 18-0 to 18-2 of the computing interconnect device 1a are provided in the same number as the number n_{buff} of parallel output stages of the buffers 12-0 to 12-3, and are arranged in ascending order according to the order of the configuration parameters. The NN configuration parameter update calculation units 18-0 to 18-2 extract, from the initial values of the configuration parameters stored in the configuration parameter memory 17, initial values wold_0 to wold_2 of the configuration parameters for which the sums of the gradient components ΣG_0 to ΣG_2 are calculated by the respective adders 13-0 to 13-2.

Then, the NN configuration parameter update calculation units 18-0 to 18-2 calculate values wnew_0 to wnew_2 of the updated configuration parameters of the neural network, based on the extracted initial values wold_0 to wold_2, and the sums of the gradient components ΣG_0 to ΣG_2 calculated by the respective adders 13-0 to 13-2, and output the calculated values to the output buffers 14-0 to 14-2. For example, in the case of using the gradient descent as the updating method, the following calculation is performed.

wnew_0←wold_0−η×ΣG_0 (7)

wnew_1←wold_1−η×ΣG_1 (8)

wnew_2←wold_2−η×ΣG_2 (9)

Here, η is a constant called a learning rate. As described in the first embodiment, since the adders 13-0 to 13-2 are arranged in ascending order according to the order of the configuration parameters, the sums of the gradient components ΣG_0 to ΣG_2 output from the adders 13-0 to 13-2 are also arranged in the order of the configuration parameters. Accordingly, the NN configuration parameter update operation units 18-0 to 18-2 repeats collective extraction of, from the configuration parameter memory 17, a same number of initial values wold_0 to wold_2 of the configuration parameters arranged in ascending order as the number n_{buff} of parallel output stages of the buffers 12-0 to 12-3, so that the initial values wold_0 to wold_2 of the configuration parameters corresponding to the sums of the gradient components ΣG_0 to ΣG_2 output from the adders 13-0 to 13-2 can be extracted.

Further, the NN configuration parameter update calculation units 18-0 to 18-2 output the values wnew_0 to wnew_2 of the updated configuration parameters to the output buffers 14-0 to 14-2, and at the same time, also overwrite the values wold_0 to wold_2 of the corresponding configuration parameters stored in the configuration parameter memory 17 by the updated values wnew_0 to wnew_2.

As in the first embodiment, the output buffers 14-0 to 14-2 of the computing interconnect device 1a are provided in the same number as the number n_{buff} of parallel output stages of the buffers 12-0 to 12-3, and are arranged in ascending order according to the order of the configuration parameters. The output buffers 14-0 to 14-2 temporarily store the updated values wnew_0 to wnew_2 of the configuration parameters calculated by the respective NN configuration parameter update calculation units 18-0 to 18-2.

The packet generation unit 15 of the computing interconnect device 1a stores the sequential number received from the parsers 11-0 to 11-3 in the data payload of each of the communication packets TP0 to TP3 addressed to the respective learning nodes 2a-0 to 2a-3, at the same time, reads out the updated values wnew_0 to wnew_2 of the configuration parameters stored in the output buffers 14-0 to 14-2, and stores the updated values in the data payload of each of the communication packets TP0 to TP3.

At that time, the packet generation unit 15 stores the updated values wnew_0 to wnew_2 of the configuration parameters stored in the output buffers 14-0 to 14-2 in the data payload of each of the communication packets TP0 to TP3 in the order of the output buffers 14-0 to 14-2 (i.e., the order of the original gradients G0_0 to G3_0, G0_1 to G3_1, and G0_2 to G3_2).

Then, the transmission units 16-0 to 16-3 of the computing interconnect device 1a simultaneously transmit the communication packets TP0 to TP3 generated by the packet generation unit 15 to the respective learning nodes 2a-0 to 2a-3.

The above-described computing interconnect device 1a can be implemented by an LSI circuit formed in an FPGA or an ASIC.

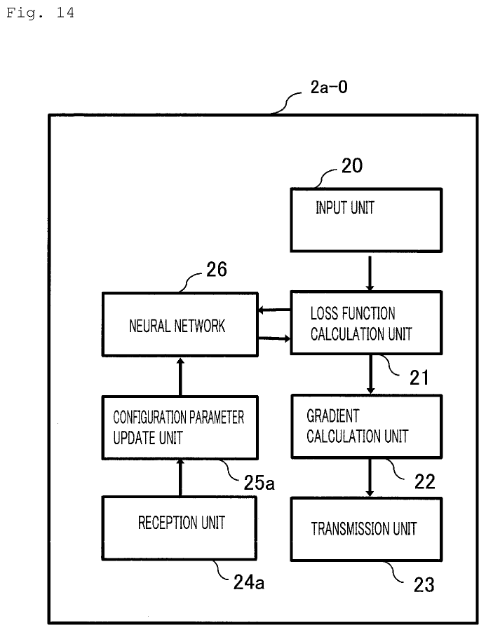

FIG. 14 is a block diagram illustrating a configuration example of the learning node 2a-0, where the same components as those in FIG. 9 are denoted by the same reference numerals. The learning node 2a-0 includes the input unit 20, the loss function calculation unit 21, the gradient calculation unit 22, the transmission unit 23, a reception unit 24a, a configuration parameter update unit 25a that updates the configuration parameters of the neural network 26 by using the updated values wnew_0 to wnew_2 of the configuration parameters stored in a communication packet transmitted from the computing interconnect device 1a, and the neural network 26.

Although the example of FIG. 14 illustrates the configuration of the learning node 2a-0, the configurations of the other learning nodes 2a-1 to 2a-3 are the same as those of the learning node 2a-0.

The reception unit 24a of each of the learning nodes 2a-0 to 2a-3 extracts the updated values wnew_0 to wnew_2 of the configuration parameters from the data payload of each of the communication packets TP0 to TP3 received from the computing interconnect device 1a.

The configuration parameter update unit 25a of each of the learning nodes 2a-0 to 2a-3 overwrites the plurality of configuration parameters of the neural network 26 (the same values as those of the above-mentioned word_0 to wold_2) by the updated values wnew_0 to wnew_2 of the configuration parameters, so that the neural network 26 is updated.

In the present embodiment, by using the computing interconnect device 1a for the All-reduce process and the update operation on the configuration parameters of the neural network, it is possible to perform the transmission and reception processes of communication packets between the computing interconnect device 1 and each of the learning nodes 2a-0 to 2a-3 simultaneously at high speed by hardware but with a slight delay due to variations in the arrival time of a communication packet among the learning nodes 2a-0 to 2a-3. Accordingly, it is possible to perform the processing at higher speed than software processing of a communication process and a gradient addition process using a conventional head node.

In particular, in the present embodiment, preparing a dedicated operation circuit for the update operation process of configuration parameters makes it possible to speed up the processing. Further, each of the sum operation on the gradient components and the update operation on the configuration parameters may be performed independently and in common for each configuration parameter regardless of the configuration of the neural network 26. Accordingly, there is an advantage that the operation units of the computing interconnect device 1a can use the same dedicated operation circuit even if the configuration of the neural network 26 in the learning nodes 2a-0 to 2a-3 is changed.

Furthermore, in the present embodiment, since the calculated values of the sums ΣG_0 to ΣG_2 of the plurality of gradient components from the learning nodes 2a-0 to 2a-3 are calculated by the plurality of adders 13-0 to 13-2 of the computing interconnect device 1a simultaneously, it is possible to perform the processing at higher speed than a sequential operation using software.

### Third Embodiment

Next, a third embodiment of the present invention will be described. In the second embodiment, all the current configuration parameter values of the neural network to be learned are recorded in the configuration parameter memory 17 of the computing interconnect device 1a. By contrast, in the present embodiment, the learning node transmits a set of gradient data and the current values of the corresponding configuration parameters, and only the current values of the configuration parameters are recorded in the configuration parameter buffer. This makes it possible for the configuration parameter buffer to be much smaller than the configuration parameter memory 17 of the second embodiment, in which all the configuration parameters need to be recorded.

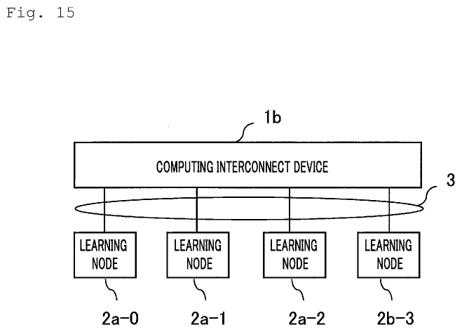

FIG. 15 is a block diagram illustrating a configuration of a distributed deep learning system according to the present embodiment. The distributed deep learning system according to the present embodiment includes one computing interconnect device 1b, four learning nodes 2a-0 to 2a-2 and 2b-3, and a communication network 3 connecting the computing interconnect device 1a and the learning nodes 2a-0 to 2a-2 and 2b-3.

<Configuration of Computing Interconnect Device>

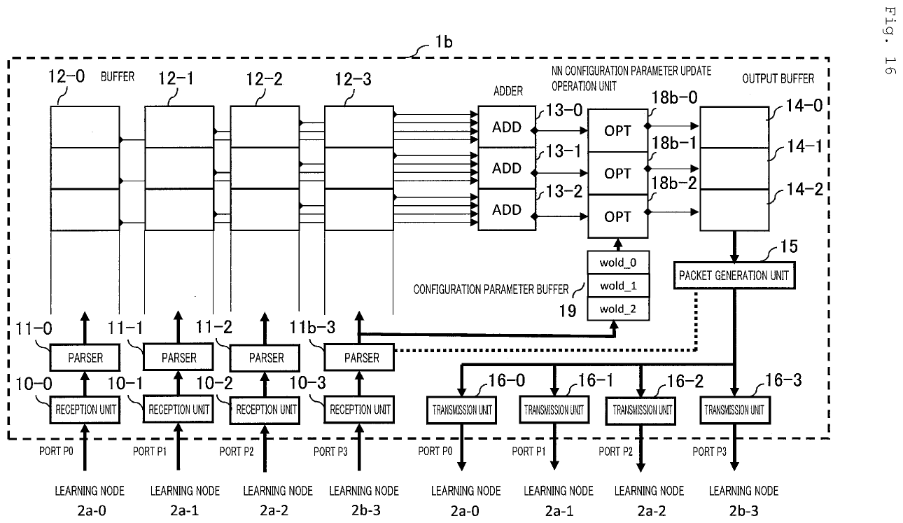

FIG. 16 is a block diagram illustrating a configuration of the computing interconnect device 1b according to the present embodiment, where the same components as those in FIGS. 7 and 12 are denoted by the same reference numerals. The computing interconnect device 1b according to the present embodiment includes the transmission and reception ports P0 to P3 connected to the learning nodes 2a-0 to 2a-2 and 2b-3 via the communication network 3, the reception units 10-0 to 10-3, parsers 11-0 to 11-2 and 11b-3, the buffers 12-0 to 12-3, the adders 13-0 to 13-2, the output buffers 14-0 to 14-2, the packet generation unit 15, the transmission units 16-0 to 16-3, NN configuration parameter update calculation units 18b-0 to 18b-2, and a configuration parameter buffer 19.

<Operation of Computing Interconnect Device>

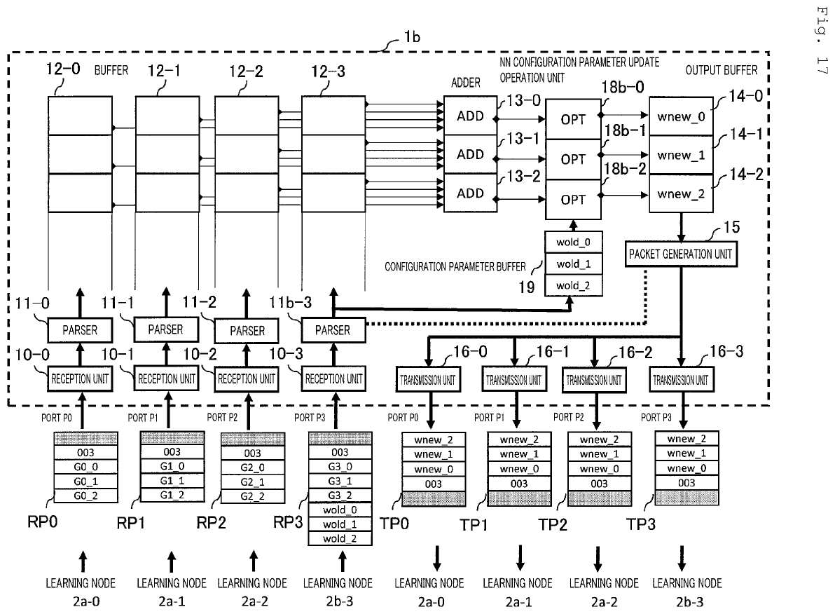

Next, a detailed operation of the computing interconnect device 1b will be described with reference to FIG. 17. As in the first embodiment, each of the learning nodes 2a-0 to 2a-2 and 2b-3 inputs learning data to the own neural networks 26 in which initial values of the configuration parameters are set, and calculates a loss function L. Next, a gradient of the loss function L is calculated. Then, the transmission unit of each of the learning nodes 2a-0 to 2a-2 and 2b-3 writes the corresponding calculation results of the gradients calculated by the gradient calculation unit 22, and the sequential number into the data payload of the corresponding one of the communication packets RP0 to RP3, and transmits the packet to the computing interconnect device 1b.

At this time, in the present embodiment, in addition to the calculation result of the gradient, the current values of the configuration parameters for which the gradient is calculated are also written into the data payload of the communication packet and transmitted to the computing interconnect device 1b. The current values of the configuration parameters of the neural network 26 of each of the learning nodes 2a-0 to 2a-2 and 2b-3 are the same in each of the learning nodes 2a-0 to 2a-2 and 2b-3.

Accordingly, in the present embodiment, only the learning node 2b-3 writes the current values wold_0 to wold_2 of the configuration parameters of the neural network 26 into the communication packet RP3 and transmits the communication packet RP3 to the computing interconnect device 1b. At this time, the gradient component values calculated by the learning node 2b-3 for the respective current values of the configuration parameters wold_0 to wold_2 are G3_0 to G3_2.

The parsers 11-0 to 11-2 and 11b-3 of the computing interconnect device 1b analyze the contents of the headers and data payloads of the communication packets RP0 to RP3 received by the reception units 10-0 to 10-3, respectively, extract the gradient component values from the data payloads, and store the values in the buffers 12-0 to 12-3.

In addition, the parser 11b-3 extracts the configuration parameter values wold_0 to wold_2 from the data payload of the communication packet RP3 received by the reception unit 10-3, and stores them in the configuration parameter buffer 19. The configuration parameter buffer 19 can sequentially store the configuration parameter values wold_0 to wold_2 written by the parser 11b-3 and output them in parallel.

When the parsers 11-0 to 11-2 and 11b-3 write, into the buffers 12-0 to 12-3, the gradient component values G0_0 to G3_0, G0_1 to G3_1, and G0_2 to G3_2 extracted from the communication packets RP0 to RP3 assigned the same sequential number which have been received from all the corresponding learning nodes 2a-0 to 2a-2 and 2b-3, the parsers 11-0 to 11-3 cause the buffers 12-0 to 12-3 to output the gradient component values. The operation of the adders 13-0 to 13-2 is as described in the first and second embodiments.

The NN configuration parameter update calculation units 18b-0 to 18b-2 of the computing interconnect device 1b are provided in the same number as the number n_{buff} of parallel output stages of the buffers 12-0 to 12-3, and are arranged in ascending order according to the order of the configuration parameters. The NN configuration parameter update calculation units 18b-0 to 18b-2 extract, from the configuration parameter buffer 19, the values wold_0 to wold_2 of the configuration parameters for which the sums of the gradient components ΣG_0 to ΣG_2 are calculated by the respective adders 13-0 to 13-2.

Then, the NN configuration parameter update calculation units 18b-0 to 18b-2 calculate values wnew_0 to wnew_2 of the updated configuration parameters of the neural network as in Equations (7) to (9), based on the extracted values wold_0 to wold_2 of the configuration parameters, and the sums of the gradient components ΣG_0 to ΣG_2 calculated by the respective adders 13-0 to 13-2, and output the calculated values to the output buffers 14-0 to 14-2.

Note that, in the present embodiment, since the current values of the configuration parameters to be updated are transmitted from the learning node 2b-3 each time they are updated, the NN configuration parameter update calculation units 18b-0 to 18b-2 do not need to update the values stored in the configuration parameter buffer 19, unlike the NN configuration parameter update calculation units 18-0 to 18-2 of the second embodiment.

The operations of the packet generation unit 15 and the transmission units 16-0 to 16-3 are as described in the second embodiment.

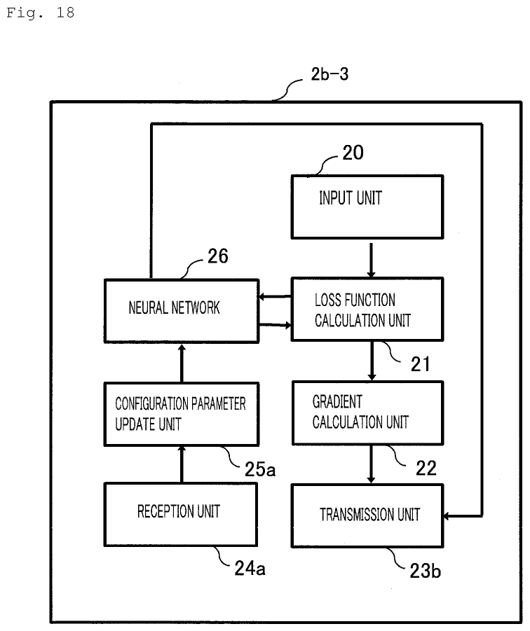

FIG. 18 is a block diagram illustrating a configuration example of the learning node 2b-3, where the same components as those in FIGS. 9 and 14 are denoted by the same reference numerals. The learning node 2b-3 includes the input unit 20, the loss function calculation unit 21, the gradient calculation unit 22, a transmission unit 23b, the reception unit 24a, the configuration parameter update unit 25a, and the neural network 26.

The configuration of each of the learning nodes 2a-0 to 2a-2 is as described in FIG. 14.

The transmission unit 23b of the learning node 2b-3 writes, into the data payload of the communication packet RP3, the current values wold_0 to wold_2 of the configuration parameters of the neural network 26, the calculation results G3_0 to G3_2 of the corresponding gradients, and a sequential number, and transmits the packet to the computing interconnect device 1b. At this time, the transmission unit 23b stores, in the same order, the current values wold_0 to wold_2 of the configuration parameters and the calculation results G3_0 to G3_2 of the corresponding gradient components in the data payload of the communication packet RP3. The other configuration of the learning node 2b-3 is as described in the second embodiment.

In the present embodiment, by using the computing interconnect device 1b for the All-reduce process and the update operation on the configuration parameters of the neural network, it is possible to perform the transmission and reception processes of communication packets between the computing interconnect device 1 and each of the learning nodes 2a-0 to 2a-2 and 2b-3 simultaneously at high speed by hardware but with a slight delay due to variations in the arrival time of a communication packet among the learning nodes 2a-0 to 2a-2 and 2b-3. Accordingly, it is possible to perform the processing at higher speed than software processing of a communication process and a gradient addition process using a conventional head node.

In particular, in the present embodiment, preparing a dedicated operation circuit for the update operation process of configuration parameters makes it possible to speed up the processing. Further, each of the sum operation on the gradient components and the update operation on the configuration parameters may be performed independently and in common for each configuration parameter regardless of the configuration of the neural network 26. Accordingly, there is an advantage that the operation units of the computing interconnect device 1b can use the same dedicated operation circuit even if the configuration of the neural network 26 in the learning nodes 2a-0 to 2a-2 and 2b-3 is changed. Furthermore, in the present embodiment, since the calculated values of the sums ΣG_0 to ΣG_2 of the plurality of gradient components from the learning nodes 2a-0 to 2a-2 and 2b-3 are calculated by the plurality of adders 13-0 to 13-2 of the computing interconnect device 1b simultaneously, it is possible to perform the processing at higher speed than a sequential operation using software.

Further, in the present embodiment, there is an advantage that the configuration parameter buffer 19 having a smaller capacity than the configuration parameter memory 17 of the second embodiment may be prepared. However, the second embodiment has an advantage that the amount of data to be transmitted in a communication packet can be small.

Each of the learning nodes described in the first to third embodiments can be implemented by a computer that includes a computational resource such as a CPU (Central Processing Unit) and a GPU (Graphics Processing Unit), a storage device, and an interface, and a program for controlling such hardware resources. The operation resources such as the CPUs and GPUs of the learning nodes execute the processes described in the first to third embodiments according to programs stored in their storage devices.

### INDUSTRIAL APPLICABILITY

The present invention is applicable to a technology for performing machine learning using a neural network.

### REFERENCE SIGNS LIST

1, 1a, 1b Computing interconnect device
2-0 to 2-3, 2a-0 to 2a-3, 2b-3 Learning nodes
3 Communication network
10-0 to 10-3, 24, 24a Reception unit
11-0 to 11-3, 11b-3 Parser
12-0 to 12-3 Buffer
13-0 to 13-2 Adder
14-0 to 14-2 Output buffer
15 Packet generation unit
16-0 to 16-3, 23, 23b Transmission unit
17 Configuration parameter memory
18-0 to 18-2, 18b-0 to 18b-2 NN configuration parameter update operation unit
19 Configuration parameter buffer
20 Input unit
21 Loss function calculation unit
22 Gradient calculation unit
25, 25a Configuration parameter update unit
26 Neural network

1.-4. (canceled)

5. A distributed deep learning system comprising:
a plurality of learning nodes; and
a computing interconnect device connected to the plurality of learning nodes via a communication network;
wherein each of the plurality of learning node includes:
a gradient calculator that calculates, from an output result obtained when learning data is input to a neural network to be learned, a gradient of a loss function with respect to configuration parameters of the neural network;
a first transmitter that generates a first packet for a plurality of component values of the gradient and transmits the first packet to the computing interconnect device;
a first receiver that receives a second packet transmitted from the computing interconnect device and acquires a plurality of values stored in the second packet; and
a configuration parameter updater that updates the configuration parameters of the neural network based on the plurality of values stored in the second packet; and
wherein the computing interconnect device includes:
a plurality of second receiver that receives the first packet from each of the plurality of learning nodes;
a plurality of analyzers that acquire the plurality of component values of the gradient from the first packet received from each of the plurality of learning nodes;
a plurality of calculators that perform a calculation process in which configuration values of gradients with respect to a same configuration parameter of the neural network are input on each of a plurality of configuration values of each gradient in parallel;
a packet generator that generates the second packet for a plurality of calculation results of the calculation process; and
a plurality of second transmitters that transmit the second packet to the plurality of learning nodes.

6. The distributed deep learning system of claim 5 further comprising:
a configuration parameter memory that stores the configuration parameters of the neural network; and
a configuration parameter update operator that updates, based on the plurality of calculation results of the calculation process, the configuration parameters stored in the configuration parameter memory.

7. The distributed deep learning system according to claim 5, wherein the computing interconnect device further includes a buffer configured to:
store the plurality of component values of the gradient transmitted from the plurality of learning nodes; and
output the plurality of component values of the gradient to the plurality of calculators in parallel.

8. A distributed deep learning system comprising:
a plurality of learning nodes; and
a computing interconnect device connected to the plurality of learning nodes via a communication network;
wherein each of the plurality of learning node includes:
a gradient calculator that calculates, from an output result obtained when learning data is input to a neural network to be learned, a gradient of a loss function with respect to configuration parameters of the neural network;
a first transmitter that generates a first packet for a plurality of component values of the gradient and transmits the first packet to the computing interconnect device;
a first receiver that receives a second packet transmitted from the computing interconnect device and acquires a plurality of values stored in the second packet; and
a configuration parameter updater that updates the configuration parameters of the neural network by overwriting the configuration parameters of the neural network with updated configuration parameters acquired based on the plurality of values stored in the second packet; and
wherein the computing interconnect device includes:
configuration parameter memory that stores the configuration parameters of the neural network;
a plurality of second receiver that receives the first packet from each of the plurality of learning nodes;
a plurality of analyzers that acquire the plurality of component values of the gradient from the first packet received from each of the plurality of learning nodes;
a plurality of calculators that perform a calculation process in which configuration values of gradients with respect to a same configuration parameter of the neural network are input on each of a plurality of configuration values of each gradient in parallel;
a configuration parameter update operator that updates, based on a plurality of calculation results of the calculation process, the configuration parameters stored in the configuration parameter memory;
a packet generator that generates the second packet for the plurality of calculation results of the calculation process; and
a plurality of second transmitters that transmit the second packet to the plurality of learning nodes.

9. The distributed deep learning system according to claim 8, wherein the computing interconnect device further includes a buffer configured to:
store the plurality of component values of the gradient transmitted from the plurality of learning nodes; and
output the plurality of component values of the gradient to the plurality of calculators in parallel.

10. A distributed deep learning system comprising:
a plurality of learning nodes; and
a computing interconnect device connected to the plurality of learning nodes via a communication network;
wherein each of the plurality of learning node includes:
a gradient calculator that calculates, from an output result obtained when learning data is input to a neural network to be learned, a gradient of a loss function with respect to configuration parameters of the neural network;
a first transmitter that generates a first packet for a plurality of component values of the gradient and transmits the first packet to the computing interconnect device;
a first receiver that receives a second packet transmitted from the computing interconnect device and acquires a plurality of values stored in the second packet; and
a configuration parameter updater that updates the configuration parameters of the neural network based on the plurality of values stored in the second packet;
wherein a first transmitter of a first learning node of the plurality of learning nodes further:
generates a third packet for current values of the configuration parameters of the neural network prior to the configuration parameter updater updating the configuration parameters of the neural network; and
transmits the third packet to the computing interconnect device;
wherein the computing interconnect device includes:
a plurality of second receiver that receives the first packet from each of the plurality of learning nodes and the third packet from the first learning node;
a plurality of analyzers that acquire the plurality of component values of the gradient from the first packet received from each of the plurality of learning nodes and the current values of the configuration parameters from the third packet received from the first learning node;
a configuration parameter buffer that stores the current values of the configuration parameters;
a plurality of calculators that perform a calculation process in which configuration values of gradients with respect to a same configuration parameter of the neural network are input on each of a plurality of configuration values of each gradient in parallel;
a configuration parameter update operator that calculates, based on a plurality of calculation results of the calculation process and the configuration parameters stored in the configuration parameter buffer, an updated value of each of the configuration parameters;
a packet generator that generates the second packet for the updated values of the configuration parameters; and
a plurality of second transmitters that transmit the second packet to the plurality of learning nodes; and
wherein configuration parameter updaters of each of the plurality of learning nodes overwrites the configuration parameters of the neural network with the updated values of the configuration parameters in the second packet.

11. The distributed deep learning system according to any one of claim 10, wherein the computing interconnect device further includes a buffer configured to:
store the plurality of component values of the gradient transmitted from the plurality of learning nodes; and
output the plurality of component values of the gradient to the plurality of calculators in parallel.
